(19) United States
(12) Patent Application Publication
(10) Pub. No.: US 2025/0260102 A1
(43) Pub. Date: Aug. 14, 2025

(54) LAMINATED BATTERY MANUFACTURING METHOD AND LAMINATED BATTERY

(71) Applicant: TOYOTA JIDOSHA KABUSHIKI KAISHA, Toyota-shi (JP)

(72) Inventors: Hirokazu Kawaoka, Nisshin-shi (JP); Sumiko Kito, Nagoya-shi (JP)

(73) Assignee: TOYOTA JIDOSHA KABUSHIKI KAISHA, Toyota-shi (JP)

(21) Appl. No.: 18/940,818

(22) Filed: Nov. 7, 2024

(30) Foreign Application Priority Data
Feb. 14, 2024 (JP) 2024-020555

(51) Int. Cl. H01M 50/186; H01M 50/105; H01M 50/193

(52) U.S. Cl. CPC H01M 50/186; H01M 50/105; H01M 50/193

(57) ABSTRACT

A method of manufacturing a laminated battery of the present disclosure is a method of manufacturing a laminated battery from an unfinished product. The unfinished product includes an electrode body and an exterior body formed of a laminate film covering the electrode body. The exterior body includes an accommodating portion for housing the electrode body, and an edge seal portion formed by welding end portions of the laminate film to each other. The edge seal portion includes a bent portion bent with respect to a main surface of the electrode body. The manufacturing method includes preparing the unfinished product, and filling an unsolidified material of the resin composition between the bent portion and the accommodating portion.

### CROSS-REFERENCE TO RELATED APPLICATION

This application claims priority to Japanese Patent Application No. 2024-020555 filed on Feb. 14, 2024, incorporated herein by reference in its entirety.

### BACKGROUND

### 1. Technical Field

The present disclosure relates to a laminated battery manufacturing method and a laminated battery.

### 2. Description of Related Art

In order to improve volume efficiency of a laminated battery, an edge seal portion of an exterior body made of a laminated film is bent. The edge seal portion is formed by welding end portions of the laminate film.

Japanese Unexamined Patent Application Publication No. 2019-200973 (JP 2019-200973 A) discloses a manufacturing method a secondary battery (hereinafter, also referred to as a “laminated battery”). The manufacturing method includes a first process and a second process. The first process and the second process are performed in this order. In the first process, a pressing plate is brought into contact with a base point of bending of an end portion (hereinafter, also referred to as an “edge seal portion”) of an exterior body. In the second process, the pressing plate and a pushing plate disposed at a position facing the pressing plate are caused to slide with the edge seal portion sandwiched. Accordingly, the edge seal portion is bent around the base point, the edge seal portion is sandwiched between the pressing plate and the pushing plate, and the bent portion is thereby formed. A surface of the pushing plate that slides on the edge seal portion has a specific surface.

### SUMMARY

However, there is a concern that the bent portion is opened by spring-back in the laminated battery disclosed in JP 2019-200973 A. “Spring-back” refers to a phenomenon in which at least a part of deformation caused by pressurization is about to return its original shape using, as a driving force, a residual stress generated by the deformation. The laminate film is soft and vulnerable. If the bent portion is opened, there is a concern that scratching (for example, a tear or the like) may occur in the bent portion (particularly, in the vicinity of the base point of the bending of the laminate film).

The present disclosure has been made in consideration of the circumstances. An object of an embodiment of the present disclosure is to provide a laminated battery manufacturing method enabling a laminated battery with reduced opening of a folded portion and with excellent reliability against scratching at the bent portion to be manufactured. An object of another embodiment of the present disclosure is to provide a laminated battery with reduced opening of a folded portion and with excellent reliability against scratching at the bent portion.

A mechanism that addresses the above object includes the following aspects.

<1> A laminated battery manufacturing method according to a first aspect is a manufacturing method of manufacturing a laminated battery from an unfinished product.

The unfinished product includes an electrode body and an exterior body configured of a laminate film covering the electrode body.
The exterior body includes an accommodating portion that accommodates the electrode body and an edge seal portion that is made by welding end portions of the laminate film.
The edge seal portion includes a bent portion that is bent with respect to a main surface of the electrode body.
The manufacturing method includes:
preparing the unfinished product; and
filling a part between the bent portion and the accommodating portion with an unsolidified material of a resin composition.

In the present disclosure, “laminate film” refers to a film having at least a metal layer, a first resin layer laminated on one main surface of the metal layer, and a second resin layer laminated on the other main surface of the metal layer.

The manufacturing method according to the first aspect includes the filling of the part between the bent portion and the accommodating portion with the unsolidified material of the resin composition. The obtained bent portion of the laminated battery is thus fixed by a solidified material (resin-filled portion) of the resin composition. As a result, according to the manufacturing method of the first aspect, it is possible to manufacture a laminated battery with reduced opening of the bent portion and with excellent reliability against scratching at the bent portion.

<2> A laminated battery manufacturing method according to a second aspect is a manufacturing method of manufacturing a laminated battery from an unfinished product.

The unfinished product includes an electrode body and an exterior body configured of a laminate film covering the electrode body.
The exterior body includes an accommodating portion that accommodates the electrode body and an edge seal portion that is made by welding end portions of the laminate film.
The edge seal portion includes a bent portion that is bent with respect to a main surface of the electrode body and a non-bent portion.
The manufacturing method includes:
preparing the unfinished product;
applying an unsolidified material of a resin composition to a surface of the bent portion on a side of the electrode body;
folding the bent portion to which the unsolidified material is applied to form a folded portion; and
folding the non-bent portion using a base line located closer to the side of the electrode body than a portion of the non-bent portion overlapping the folded portion as a bending line.

The manufacturing method according to the second aspect includes the folding of the bent portion to which the unsolidified material is applied to form the folded portion. The obtained folded portion of the laminated battery is thus fixed by a solidified material (resin-filled portion) of the resin composition. As a result, according to the manufacturing method of the second aspect, it is possible to manufacture a laminated battery with reduced opening of the bent portion and with excellent reliability against scratching at the bent portion.

<3> The laminated battery according to a third aspect includes:

an electrode body;
an exterior body that is configured of a laminate film covering the electrode body; and a resin-filled portion.
The exterior body includes an accommodating portion that accommodates the electrode body and an edge seal portion that is made by welding end portions of the laminate film.
The edge seal portion includes a bent portion that is bent with respect to a main surface of the electrode body.
The resin-filled portion includes a solidified material of a resin composition filled between the bent portion and the accommodating portion.

In the present disclosure, the “solidified product of the resin composition” indicates a resin composition that is in a solid state at an operating temperature (for example, 120° C. or lower) of the laminated battery.

In the third aspect, the resin-filled portion includes the solidified material of the resin composition filled between the bent portion and the accommodating portion. The bent portion of the laminated battery is thus fixed by the resin-filled portion. As a result, the laminated battery according to the third aspect has reduced opening of the bent portion and has excellent reliability against scratching at the bent portion.

<4> A laminated battery according to a fourth aspect includes:

an electrode body;
an exterior body that is configured of a laminate film covering the electrode body; and
a resin-filled portion.
The exterior body includes an accommodating portion that accommodates the electrode body and an edge seal portion that is made by welding end portions of the laminate film.
The edge seal portion has a bent portion that is bent with respect to a main surface of the electrode body.
The bent portion has a folded portion and a non-folded portion.
The resin-filled portion includes a solidified material of a resin composition filled between the folded portion and the non-folded portion.

According to the manufacturing method of the fourth aspect, the resin-filled portion includes the solidified material of the resin composition filled between the folded portion and the non-folded portion. The folded portion of the laminated battery is thus fixed by the resin-filled portion. As a result, the laminated battery according to the fourth aspect has reduced opening of bent portion and has excellent reliability against scratching at the bent portion.

According to an embodiment of the present disclosure, there is provided a laminated battery manufacturing method enabling a laminated battery with reduced opening of a bent portion and with excellent reliability against scratching at the bent portion to be manufactured.

According to another embodiment of the present disclosure, there is provided a laminated battery with reduced opening of a bent portion and with excellent reliability against scratching at the bent portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view of a laminated battery according to a first embodiment;

FIG. 2 shows a cross-sectional view of II-II of FIG. 1;

FIG. 3 is a diagram schematically illustrating a configuration of a bending device used in the method of manufacturing a laminated battery according to the first embodiment;

FIG. 4 is a diagram for explaining a method of manufacturing a laminated battery according to the first embodiment;

FIG. 5 is a cross-sectional view of a laminated battery according to a second embodiment; and

FIG. 6 is a diagram for explaining a manufacturing method of the laminated battery according to the second embodiment.

### DETAILED DESCRIPTION OF EMBODIMENTS

In the present disclosure, a numerical range indicated by using “to” means a range including numerical values described before and after “to” as a minimum value and a maximum value, respectively. In the numerical range described in the present disclosure in a stepwise manner, the upper limit value or the lower limit value described in a certain numerical range may be replaced with the upper limit value or the lower limit value of the numerical range described in another stepwise manner. In the present disclosure, a combination of two or more preferred embodiments is a more preferred embodiment. In the present disclosure, the term “step” is included in the term as long as the intended purpose of the step is achieved, even if it is not clearly distinguishable from other steps as well as independent steps.

Hereinafter, a method of manufacturing a laminated battery of the present disclosure and an embodiment of a laminated battery of the present disclosure will be described with reference to the drawings. In the drawings, the same or corresponding parts are denoted by the same reference numerals, and description thereof will not be repeated.

### (1) FIRST EMBODIMENT

A method of manufacturing a laminated battery according to the first embodiment is a method of manufacturing a laminated battery 1A (hereinafter, also referred to as “battery A1”) from an unfinished product 1a. The manufacturing process includes a preparation process, an application process, a consolidation process, and a finishing bend process. The preparation step, the coating step, the solidification step, and the finish bending step are performed in this order.

### (1.1) Laminated battery

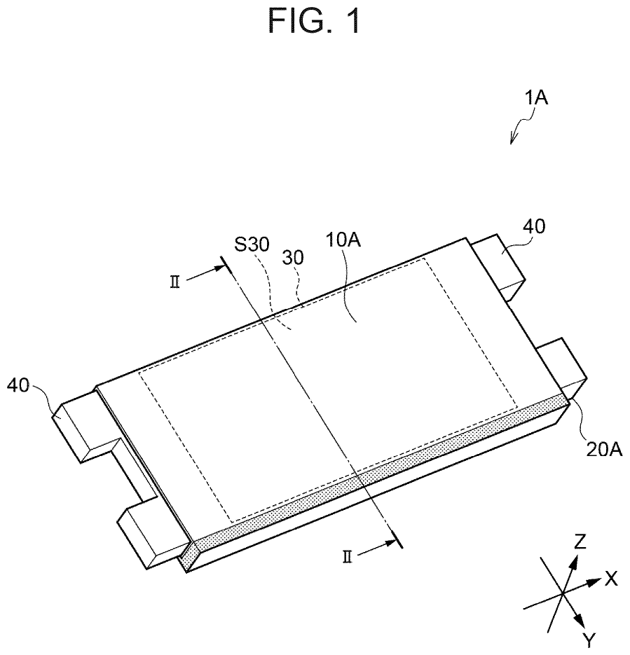

As shown in FIG. 1, the battery 1A includes an exterior body 10A, a resin-filled portion 20A, an electrode body 30, and a pair of terminals 40. One of the pair of terminals 40 is a positive electrode terminal. The other of the pair of terminals 40 is a negative electrode terminal. The electrode body 30 is a rectangular parallelepiped.

In the first embodiment, the longitudinal direction of the main surface S30 of the electrode body 30 is defined as the X-axis direction, the Y-axis direction of the main surface S30 of the electrode body 30 is defined as the Y-axis direction, and the thickness direction of the electrode body 30 is defined as the Z-axis direction. Each of the X-axis, the Y-axis, and the Z-axis is orthogonal to each other. Note that these orientations do not limit the orientation of the laminated battery of the present disclosure when used.

The pair of terminals 40 are disposed to face each other with the electrode body 30 interposed therebetween. Each of the pair of terminals 40 is electrically connected to the electrode body 30. The exterior body 10A covers the electrode body 30. The electrode body 30 is sealed by a pair of terminals 40 and an exterior body 10A.

### (1.1.1) Exterior Body

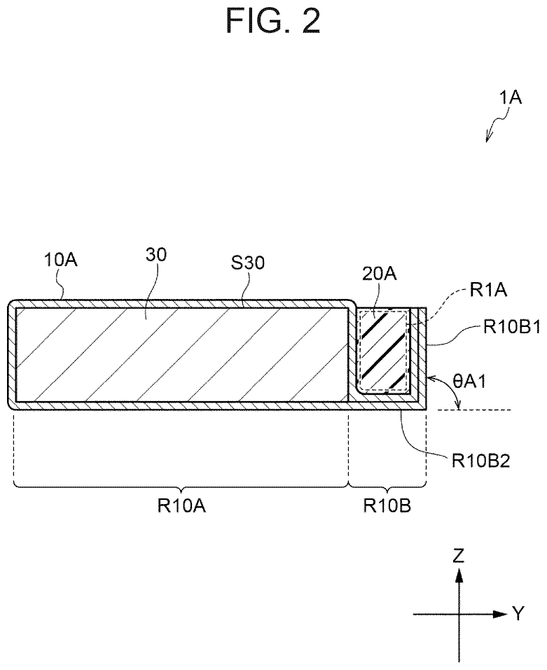

The exterior body 10A is composed of one laminated film. As shown in FIG. 2, the exterior body 10A has an accommodating portion R10A and an edge scaling portion R10B. The accommodating portion R10A accommodates the electrode body 30. The edge scaling portion R10B is formed by welding end portions of the laminated films to each other. The edge scaling portion R10B has a bent portion R10B1 and a non-bent portion R10B2. The bent portion R10B1 is bent with respect to the main surface S30 of the electrode body 30. In the first embodiment, the angle θA (hereinafter, also referred to as “bending angle θA”) of the bent portion R10B1 with respect to the main surface S30 (see FIG. 2) is, for example, approximately 90°. The non-bent portion R10B2 extends in the Y-axis positive direction from an end portion on the Z-axis negative direction side of the side surface on the Y-axis positive direction side of the accommodating portion R10A. The bent portion R10B1 and the accommodating portion R10A face each other.

The laminate film is formed by laminating an outer insulating layer, a metal layer, and an inner insulating layer in this order. The thickness of the laminate film may be 70 μm to 220 μm. The outer insulating layer functions as a protective layer for the metal layer. Examples of the protective layers include polyethylene terephthalate (PET) and nylon. The metallic layers block the ingress and egress of gases (e.g., moisture, air, etc.) between the exterior of the battery 1A and the interior of the battery 1A. Examples of the material of the metal layer include aluminum, an aluminum alloy, and stainless steel. The inner insulating layer electrically insulates the pair of terminals 40 and the electrode body 30 from the metal layer. Examples of the inner insulating layers include polypropylene (PP) and polyethylene (PE).

### (1.1.2) Resin-Filled Portion

The resin-filled portion 20A fixes the bent portion R10B1 of the exterior body 10A. The resin-filled portion 20A includes a solidified material. The solidified material is filled in a gap R1A between the bent portion R10B1 and the accommodating portion R10A. The resin composition may be a known resin composition (for example, a thermoplastic resin composition, a thermosetting resin composition, or a photocurable resin composition) as long as it is a resin composition that is in a solid-state at an operating temperature of the battery 1A (for example, 120° C. or lower). The resin composition includes a known resin (for example, a thermoplastic resin, a thermosetting resin, a photocurable resin, or the like). The resin composition may further contain a polymerization initiator, a curing agent, or the like, if necessary.

### (1.1.3) Electrode Body

The electrode body 30 functions as a power generation element of the battery 1A. The electrode body 30 may be any known electrode body. The electrode body 30 may include a plurality of unit electrode bodies. The unit electrode body may include a so-called solid electrolyte (the content of the electrolyte as the electrolyte is less than 5% by mass based on the total amount of the electrolyte) using an inorganic solid electrolyte as the electrolyte. The structure of the unit electrode body may be a structure in which a positive electrode current collector, a positive electrode layer, a solid electrolyte layer, a negative electrode layer, and a negative electrode current collector are stacked in this order along the Z-axis direction.

### (1.1.4) Terminal

The terminal 40 is a rectangular parallelepiped. The shape of the terminal 40 as viewed in the Z-axis direction is a U-shape. Examples of the material of the terminal 40 include metallic materials (for example, SUS and the like).

### (1.2) Unfinished Product

The unfinished product 1a is similar to the battery 1A except that the unfinished product 1a does not include the resin-filled portion 20A and that the bending angle θA is an acute angle.

### (1.3) Bending Device

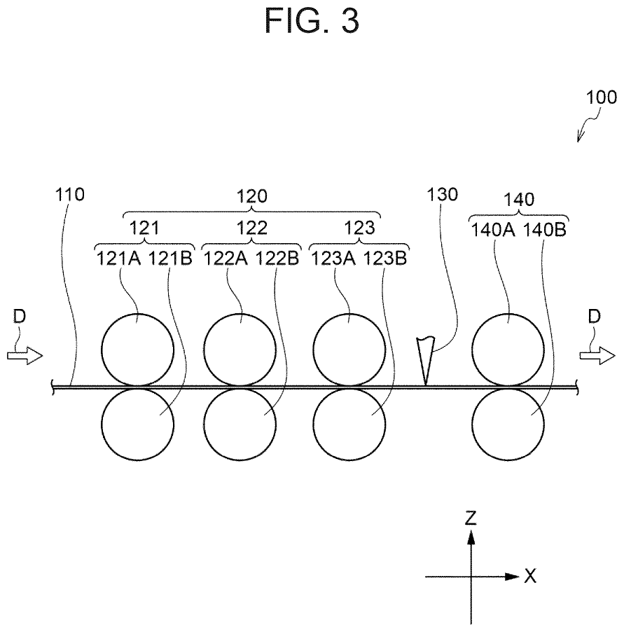

In the first embodiment, the bending device 100 is used in the preparation step, the coating step, and the finish bending step. The bending device 100 bends the edge sealing portion R10B and applies an unsolidified material. As illustrated in FIG. 3, the bending device 100 includes a conveyance unit 110, an upstream roller group 120, a dispenser 130, and a downstream roller group 140. The upstream roller group 120, the dispenser 130, and the downstream roller group 140 are arranged in this order along the conveying direction D.

The conveyance unit 110 is configured to convey the unfinished product 1a in the conveying direction D.

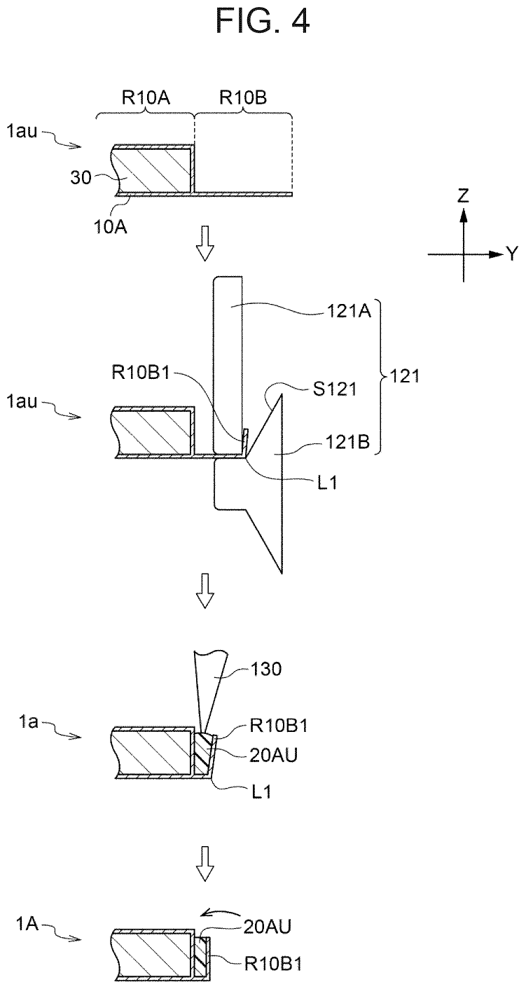

The upstream roller group 120 bends the edge sealing portion R10B so that the bending angle θA is from 0° to the third angle (for example, 85°). The baseline L1 (see FIGS. 2 and 4) is a fold line. The upstream roller group 120 includes a pair of rollers 121, a pair of rollers 122, and a pair of rollers 123. The pair of rollers 121, the pair of rollers 122, and the pair of rollers 123 are arranged in this order along the conveying direction D.

The pair of rollers 121 bends the bent portion R10B1 so that the bending angle θA is from 0° to the first angle (for example, 30°). The pair of rollers 121 includes a back-up roller 121A and a folding roller 121B. The folding roller 121B has an inclined surface S121 (see FIG. 4).
The edge sealing portion R10B is sandwiched between the pair of rollers 121 and is bent along the inclined surface S121.
The pair of rollers 122 bends the bent portion R10B1 so that the bending angle θA is the second angle (for example, 60°) from the first angle. The pair of rollers 122 includes a back-up roller 122A and a folding roller 122B. The folding roller 122B has a first inclined surface. The bent portion R10B1 is sandwiched between the pair of rollers 122 and is bent along the first inclined surface.
The pair of rollers 123 bends the bent portion R10B1 so that the bending angle θA is the third angle (for example, 85°) from the second angle. The pair of rollers 123 includes a back-up roller 123A and a folding roller 123B. The folding roller 123B has a second inclined surface. The bent portion R10B1 is sandwiched between the pair of rollers 123 and is bent along the second inclined surface.

The dispenser 130 applies an unsolidified resin-composition to the gap R1A. The dispenser 130 may be a known dispenser.

The downstream roller group 140 bends the bent portion R10B1 such that the bending angle θA is approximately 90° from the third angle. The downstream roller group 140 includes an inclined roller 140A and a bending roller 140B. The rotational axis direction of the inclined roller 140A is inclined with respect to the Y axis direction. The rotational axis direction of the inclined roller 140A with respect to the Y-axis direction is, for example, 5°. The surface layer of the bending roller 140B is formed of an elastic material. The bending roller 140B is biased in the Y-axis direction (a direction perpendicular to the conveying direction D) by a biasing unit (for example, a spring or the like).

### (1.4) Preparation Process

In the preparation step, an unfinished product 1a is prepared. Specifically, in the first embodiment, the edge sealing portion R10B of the unfolded product 1au (see FIG. 4) is sandwiched between the upstream roller groups 120 of the bending device 100 to form the unfinished product 1a. The unfolded product 1au is similar to the unfinished product 1a except that the edge sealing portion R10B is unfolded. Methods for preparing unfolded product 1au are known methods.

### (1.5) Coating Process

In the coating step, as shown in FIG. 4, an unsolidified resin-composition is filled between the bent portion R10B1 and the accommodating portion R10A. Specifically, in the first embodiment, an unsolidified resin-composition is applied to a gap R1A of an unfinished product 1a to form a coating 20AU.

### (1.6) Finishing Bending Process

In the finishing bending step, as shown in FIG. 4, the bent portion R10B1 is bent so that the bending angle θA is approximately 90°. Specifically, in the first embodiment, the unfinished product 1a on which the coating material 20AU is formed is sandwiched by the downstream roller group 140 of the bending device 100 to bend the bent portion R10B1.

### (1.7) Solidification Process

In the solidification step, the coating 20AU is solidified to form a resin-filled portion 20A. Thereby, a battery 1A is obtained.

The solidification method is appropriately selected according to the type of the resin composition and the like. When the resin composition is a thermoplastic resin composition or a thermosetting resin composition, the coating 20AU may be solidified by being cooled. The cooling method is not particularly limited, and examples thereof include a method of leaving at room temperature (25° C.), a method of blowing cooling air, and the like. When the resin composition is a photocurable resin composition, the coating 20AU may be solidified by irradiating with active energy rays (for example, visible light, ultraviolet rays, X-rays, or electron beams).

### (1.8) Action and Effect

As described with reference to FIGS. 1 to 3, the manufacturing method of the first embodiment includes a preparation step and a coating step. Thus, the bent portion R10B1 of the obtained battery 1A is fixed by the solidified material (resin-filled portion 20A) of the resin composition. Consequently, in the manufacturing process of the first embodiment, it is possible to manufacture a laminated battery 1A in which the opening of the bent portion R10B1 is suppressed and the reliability against the flaw of the bent portion R10B1 is excellent.

As described with reference to FIGS. 1 to 3, the battery 1A includes an electrode body 30, an exterior body 10A, and a resin-filled portion 20A. The exterior body 10A has an accommodating portion R10A and an edge sealing portion R10B. The edge sealing portion R10B includes a bent portion R10B1. The resin-filled portion 20A includes a solidified material of the resin-composition filled between the bent portion R10B1 and the accommodating portion R10A. Thus, the bent portion R10B1 of the battery 1A is fixed by the resin-filled portion 20A. Consequently, in the battery 1A, the opening of the bent portion R10B1 is suppressed, and the reliability against the flaw of the bent portion R10B1 is excellent.

### (2) SECOND EMBODIMENT

A method of manufacturing a laminated battery according to the second embodiment is a method of manufacturing a laminated battery 1B (hereinafter, also referred to as “battery 1B”) from an unfinished product 1b. The manufacturing method includes a preparation step, a coating step, a folding step, a solidifying step, and a folding step. The preparation, application, folding, consolidation, and folding steps are performed in this order.

### (2.1) Laminated Battery

The battery 1B is similar to the battery 1A except that the edge seal portion bends and the resin-filled portion mainly differs. The battery 1B includes an exterior body 10B, a resin-filled portion 20B, an electrode body 30, and a pair of terminals 40.

### (2.1.1) Exterior Body

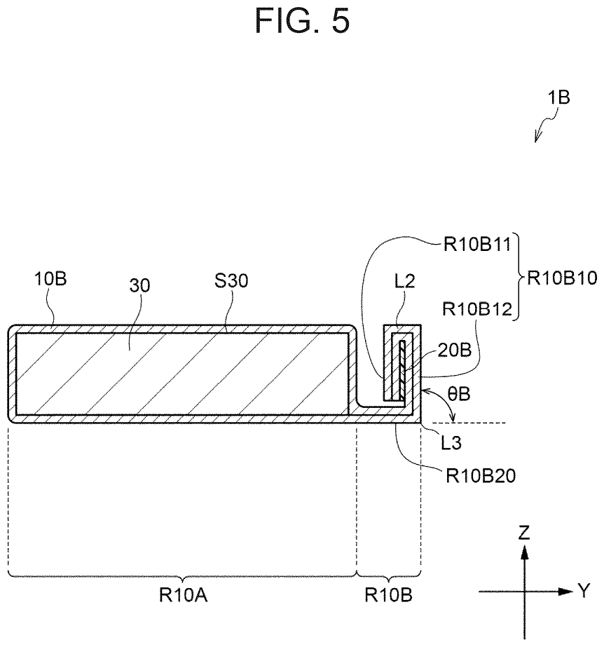

The exterior body 10B is similar to the exterior body 10A except that the bending of the edge sealing portion R10B differs. The exterior body 10A has an accommodating portion R10A and an edge sealing portion R10B. The edge scaling portion R10B has a bent portion R10B10 and a non-bent portion R10B20. The bent portion R10B10 has a folded portion R10B11 and a non-folded portion R10B12. The bent portion R10B10 is bent with respect to the main surface S30 of the electrode body 30. In the second embodiment, the angle θB (hereinafter, also referred to as “bending angle θB”) of the bent portion R10B10 with respect to the main surface S30 (see FIG. 5) is, for example, approximately 90°. The non-bent portion R10B20 extends in the Y-axis positive direction from an end portion on the Z-axis negative direction side of the side surface on the Y-axis positive direction side of the accommodating portion R10A. The folded portion R10B11 and the unfolded portion R10B12 face each other.

### (2.1.2) Resin-Filled Portion

The resin-filled portion 20B fixes the folded portion R10B11 of the exterior body 10B. The resin-filled portion 20B includes a solidified material. The solidified material is filled between the folded portion R10B11 and the unfolded portion R10B12. Examples of the resin composition on the resin-filled portion 20B include the same as those exemplified as the resin composition on the resin-filled portion 20A.

### (2.2) Unfinished Product

The unfinished product 1b is similar to the battery 1B except that the unfinished product 1b does not include the resin-filled portion 20B and that the bent portion R10B10 is not formed.

### (2.3) Bending Device

In the second embodiment, a folding device (not shown) is used for the preparation step, the coating step, and the folding step. The bending device bends the edge sealing portion R10B and applies an unsolidified material. The bending device is the same as the bending device 100 except that the configurations of the upstream roller group and the downstream roller group are different from each other. The bending device includes a conveyance unit 110, an upstream roller group, a dispenser 130, and a downstream roller group. The upstream roller group, the dispenser 130, and the downstream roller group are arranged in this order along the conveying direction D.

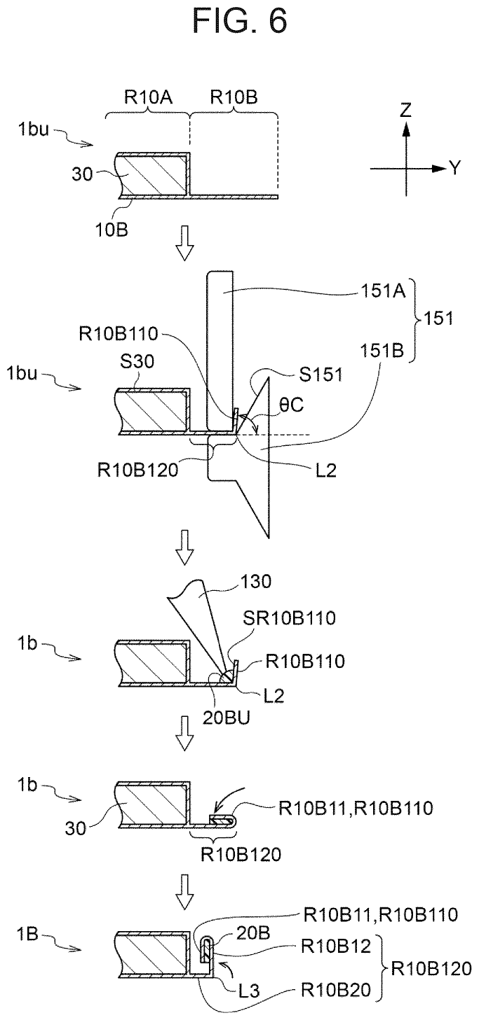

The upstream roller group bends the edge sealing portion R10B such that the angle θC of the portion R10B110 corresponding to the folded portion R10B11 of the battery 1B with respect to the main surface S30 is approximately 90° from 0° (see FIG. 6). The portion R10B110 is hereinafter also referred to as “bent portion R10B110”. The angle θC is hereinafter also referred to as a “bending angle θC”. The baseline L2 (see FIGS. 5 and 6) is a fold line. The upstream roller group includes a pair of first rollers 151 (see FIG. 6), a pair of second rollers, and a pair of third rollers. The pair of first rollers 151, the pair of second rollers, and the pair of third rollers are arranged in this order along the conveying direction D.

The pair of first rollers 151 bends the bent portion R10B110 so that the bending angle θC is from 0° to the fourth angle (for example, 30°). The pair of first rollers 151 includes a first backup roller 151A and a first folding roller 151B. The first folding roller 151B has a third inclined surface S151 (see FIG. 6). The edge sealing portion R10B is sandwiched between the pair of first rollers 151 and is bent along the third inclined surface S151 of the first bending roller 151B.
The pair of second rollers bends the bent portion R10B110 so that the bending angle θC is the fifth angle (for example, 60°) from the fourth angle. The pair of second rollers includes a second backup roller and a second folding roller. The second bending roller has a fourth inclined surface. The bent portion R10B 110 is sandwiched between the pair of second rollers and is bent along the fourth inclined surface of the second bending roller.
The pair of third rollers bends the bent portion R10B110 such that the bending angle θC is approximately 90° from the fifth angle. The pair of third rollers includes a third backup roller and a third folding roller. The third bending roller has a fifth inclined surface. The bent portion R10B110 is sandwiched between a pair of third rollers, and is bent along the fifth inclined surface of the third bending roller.

The downstream-side roller group bends the bent portion R10B110 such that the bending angle θC is approximately 0° from the third angle. That is, the bent portion R10B110 is folded to become the folded portion R10B11. The upstream roller group includes a pair of fourth rollers, a pair of fifth rollers, and a pair of sixth rollers. The pair of fourth rollers, the pair of fifth rollers, and the pair of sixth rollers are arranged in this order along the conveying direction D.

The pair of fourth rollers bends the bent portion R10B110 such that the bending angle θC is approximately 90° to a sixth angle (e.g., 120°). The pair of fourth rollers includes a first contact roller and a first opposing roller. The first contact roller has a first large-diameter portion, a first small-diameter portion, and a first planar portion connecting the first large-diameter portion and the first small-diameter portion. The first opposing roller has a second large-diameter portion, a second small-diameter portion, and a first inclined surface portion connecting the second large-diameter portion and the second small-diameter portion. The bent portion R10B110 is sandwiched between the pair of fourth rollers and is bent along the first inclined surface portion of the first opposing roller.
The pair of fifth rollers bends the bent portion R10B110 so that the bending angle θC is a seventh angle (for example, 150°) from the sixth angle. The pair of fifth rollers includes a second contact roller and a second opposing roller. The second contact roller has a third large-diameter portion, a third small-diameter portion, and a second planar portion connecting the third large-diameter portion and the third small-diameter portion. The second opposing roller has a fourth large-diameter portion, a fourth small-diameter portion, and a second inclined surface portion connecting the fourth large-diameter portion and the fourth small-diameter portion. The bent portion R10B110 is sandwiched between the pair of fifth rollers and is bent along the second inclined surface portion of the second opposing roller. The pair of sixth rollers bends the bent portion R10B110 such that the bending angle θC is approximately 0° from the seventh angle. The pair of sixth rollers includes a third contact roller and a third opposing roller. The third contact roller has a fifth large-diameter portion, a fifth small-diameter portion, and a third planar portion connecting the fifth large-diameter portion and the fifth small-diameter portion. The third opposing roller has a sixth large-diameter portion, a sixth small-diameter portion, and a third inclined surface portion connecting the sixth large-diameter portion and the sixth small-diameter portion. The bent portion R10B110 is sandwiched between the pair of sixth rollers and is bent along the third inclined surface portion of the third opposing roller.

### (2.4) Preparation Process

In the preparation step, an unfinished product 1b is prepared. Specifically, in the second embodiment, an unfinished product 1b is formed by sandwiching the edge sealing portion R10B of the unfolded product 1bu (see FIG. 6) between the upstream rollers of the bending device. The unfolded product 1bu is similar to the unfinished product 1b except that the edge sealing portion R10B is unfolded. Methods for preparing unfolded product 1bu are known methods.

### (2.5) Coating Process

In the coating step, as shown in FIG. 6, an unsolidified material is applied to the surface of the bent portion R10B110 on the electrode body 30. Specifically, in the second embodiment, an unsolidified resin-composition is applied to the surface SR10B110 (see FIG. 6) of the bent portion R10B110 on the electrode body 30 to form a coating 20BU.

### (2.6) Folding Process

In the folding step, as shown in FIG. 6, a bent portion R10B110 to which an unsolidified material is applied is folded to form a folded portion R10B11. Specifically, in the second embodiment, the folded portion R10B11 is formed by sandwiching the bent portion R10B110 to which the unsolidified material is applied between the downstream-side roller groups of the bending device.

### (2.7) Solidification Process

In the solidification step, the coating 20BU is solidified to form a resin-filled portion 20B. The solidification method of the second embodiment is the same as that exemplified as the solidification method of the first embodiment.

### (2.8) Folding Process

In the folding step, as shown in FIG. 6, the non-bent portion R10B120 is folded using, as a folding line, a baseline L3 located closer to the electrode body 30 with respect to a portion overlapping with the folded portion R10B11 in the non-bent portion R10B120. Thereby, a battery 1B is obtained.

The folding method is not particularly limited, and may be a known method.

### (2.9) Action and Effect

As described in FIG. 5 and FIG. 6, the manufacturing method of the second embodiment includes a preparation process, an application process, a folding process, and a folding process. Thus, the folded portion R10B11 of the obtained battery 1B is fixed by the resin-filled portion 20B. As a consequence, in the manufacturing process of the second embodiment, it is possible to manufacture a laminated battery 1B in which the opening of the bent portion R10B10 is suppressed and the reliability against the flaw of the bent portion R10B10 is excellent.

As described with reference to FIGS. 5 and 6, the battery 1B includes an electrode body 30, an exterior body 10B, and a resin-filled portion 20B. The exterior body 10B has an accommodating portion R10A and an edge sealing portion R10B. The edge sealing portion R10B has a bent portion R10B10. The bent portion R10B10 has a folded portion R10B11 and a non-folded portion R10B12. The resin-filled portion 20B includes a solidified material of the resin composition filled between the folded portion R10B11 and the non-folded portion R10B12. Thus, the folded portion R10B11 of the battery 1B is fixed by the resin-filled portion 20B. As a consequence, the laminated battery 1B is excellent in reliability against scratches on the bent portion R10B 10 and is suppressed in opening of the bent portion R10B10.

### (3) MODIFICATION

The method of manufacturing the laminated battery according to the first embodiment includes a solidification step and a finish bending step, but the present disclosure is not limited thereto. The method for manufacturing a laminated battery according to the first embodiment may not include a solidification step and a finish bending step.

The method of manufacturing the laminated battery according to the second embodiment includes a solidification step, but the present disclosure is not limited thereto. The method for manufacturing a laminated battery according to the second embodiment may not include a solidification step.

In the second embodiment, the resin-composition solidified material is not filled between the accommodating portion R10A and the bent portion R10B10. In the second embodiment, a solidified material may be filled between the accommodating portion R10A and the bent portion R10B10.

What is claimed is:

1. A manufacturing method of manufacturing a laminated battery from an unfinished product, the unfinished product including an electrode body and an exterior body configured of a laminate film covering the electrode body, the exterior body including an accommodating portion that accommodates the electrode body and an edge seal portion made by welding end portions of the laminate film, and the edge seal portion including a bent portion that is bent with respect to a main surface of the electrode body, wherein the manufacturing method includes:
preparing the unfinished product; and
filling a part between the bent portion and the accommodating portion with an unsolidified material of a resin composition.

2. A manufacturing method of manufacturing a laminated battery from an unfinished product, the unfinished product including an electrode body and an exterior body configured of a laminate film covering the electrode body, the exterior body including an accommodating portion that accommodates the electrode body and an edge seal portion made by welding end portions of the laminate film, and the edge seal portion including a bent portion that is bent with respect to a main surface of the electrode body and a non-bent portion, wherein the manufacturing method includes:
preparing the unfinished product;
applying an unsolidified material of a resin composition to a surface of the bent portion on a side of the electrode body;
folding the bent portion to which the unsolidified material is applied to form a folded portion; and
folding the non-bent portion using a base line located closer to the side of the electrode body than a portion of the non-bent portion overlapping the folded portion as a bending line.

3. A laminated battery comprising:
an electrode body;
an exterior body that is configured of a laminate film covering the electrode body; and
a resin-filled portion, wherein
the exterior body has an accommodating portion that accommodates the electrode body and an edge seal portion made by welding end portions of the laminate film,
the edge seal portion includes a bent portion that is bent with respect to a main surface of the electrode body, and
the resin-filled portion includes a solidified material of a resin composition filled between the bent portion and the accommodating portion.
